(19) United States
(12) Patent Application Publication
(10) Pub. No.: US 2026/0072921 A1
(43) Pub. Date: Mar. 12, 2026

(54) INFORMATION RETRIEVAL SYSTEM, METHOD AND USER INTERFACE

(71) Applicant: PYFOI HOLDINGS LIMITED, Hunua (NZ)

(72) Inventor: Anthony John BELSHAM, Hunua (NZ)

(73) Assignee: PYFOI HOLDINGS LIMITED, Hunua (NZ)

(21) Appl. No.: 19/326,467

(22) Filed: Sep. 11, 2025

(30) Foreign Application Priority Data
Sep. 12, 2024 (NZ) 814516

(51) Int. Cl. G06F 16/2457; G06F 3/0484; G06F 9/451; G06F 16/248; G06F 16/25

(52) U.S. Cl. CPC G06F 16/24578; G06F 3/0484; G06F 9/451; G06F 16/248; G06F 16/258

(57) ABSTRACT

In one aspect the invention provides a system method and computer executable instructions to generate a graphical user interface (GUI) which is configured to solicit domain identity information from a user. The GUI then presents domain attribute information to the user, and solicits from the user priority indications related at least one domain attribute presented to the user. The invention then operates to assemble result information using a set of priority indications received from the user, and to present result information to the user formatted using at least one received priority indication.

### TECHNICAL FIELD

This invention relates to a system, method and user interface for retrieving information. In various implementations the invention may be employed to retrieve internet hosted information when the user has limited familiarity with the subject matter related to the information sought.

### BACKGROUND ART

The internet provides a useful resource for people seeking information. Due to the amount of information hosted it can be difficult for users to find information which is relevant to a problem or project that they are involved with, particularly when the user has limited familiarity with the subject matter related to their project or problem.

Historically internet search engines have allowed users to specify characterising keywords as a query which retrieve links to a number of potentially relevant webpages. A variety of algorithms are used by search engines to present links to these pages with the order the links are presented being dictated by perceived relevance to the keyword query entered by the user.

Traditional search engines perform adequately when users understand how to properly structure a Boolean based search query and also when they understand the relative context of keywords to a specific subject matter domain. These well informed users are able to formulate targeted precise queries to find relevant results quickly.

More recently artificial intelligence (AI) systems have been developed and used as an alternative way of retrieving internet hosted information. AI systems are able to act on natural language queries to provide concise summaries of information hosted across collections of webpages. Although these summaries may be more user-friendly than the basic result links of search engines they still provide information which may not be pertinent to a user. In practice they result in a user having to learn about a new subject matter domain before for being able to determine the specific information they should be asking for to progress their project or resolve their problem.

In practice these existing prior art technologies require a user to educate themselves about a subject matter domain before being able to search for information pertinent to their circumstances. This preliminary research and education process is required to provide the background knowledge required to formulate exact and precise search engine queries, or AI prompts which are likely to retrieve information of relevance to the user's circumstances.

It would be of advantage to have improvements in the field of information search and retrieval technologies which addressed any of the above issues or at least provided the public with an alternative choice. In particular, it would be of advantage to have improvements which allowed a user with limited familiarity with a subject matter area to easily retrieve relevant information.

### SUMMARY OF THE DISCLOSURE

According to one aspect of the present invention there is provided non-transitory computer-readable storage medium configured to store instructions, the instructions when executed by a processor of an information retrieval system cause the information retrieval system to generate a graphical user interface (GUI) configured to:
solicit domain identity information from a user,
present domain attribute information to the user,
solicit from the user priority indications related at least one domain attribute presented to the user,
assemble result information using a set of priority indications received from the user, and
present result information to the user formatted using at least one received priority indication.

Preferably the user interface may optionally solicit from the user a reassigned set of priority indications prior to assembling result information.

Preferably the user interface uses graphical interactions to receive user priority indications.

According to another aspect of the present invention there is provided an information retrieval system including a processor programmed with computer executable instructions retrieved from a non-transitory computer-readable storage medium, the instructions being configured to:
solicit domain identity information from a user,
present domain attribute information to the user,
solicit from the user priority indications related at least one domain attribute presented to the user,
assemble result information using a set of priority indications received from the user, and
present result information to the user formatted using at least one received priority indication

Preferably the information retrieval system may optionally solicit from the user a reassigned set of priority indications prior to assembling result information.

According to a further aspect of the present invention there is provided a method of information retrieval characterised by the steps of
soliciting domain identity information from a user,
present domain attribute information to the user,
soliciting from the user priority indications in respect of at least one domain attribute,
assembling result information using a set of priority indications received from the user, and
presenting result information to the user formatted using at least one priority indication

Preferably a reassigned set of priority indications may optionally be solicited from the user prior to assembling result information.

The present invention relates to a technology which is to be used to retrieve internet hosted information. The invention is embodied through various aspects, including a method of information retrieval, an information retrieval system, and a user interface for such an information retrieval system.

In preferred embodiments the invention also encompasses the provision of a non-transitory computer readable storage medium configured to store computer executable instructions which when executed provide a graphical user interface for an information retrieval system. The graphical nature of this interface allows content to be presented and responses solicited in an intuitive manner. In such embodiments well known graphical interactions may be employed such as for example touch or pointer clicks, drag and drop operations, pointer gestures and/or user voice or physical gesture inputs.

Reference throughout this specification is made to the invention being embodied by an information retrieval system with an associated graphical user interface. Those skilled in the art will however appreciate that the invention also encompasses a method of information retrieval and other aspects in various embodiments.

The information retrieval system implemented with the invention includes a processor or processors loaded with computer executable instructions. Those skilled in the art will appreciate that a wide range and variety of information focused technologies may be used in conjunction with the invention to provide such a processor.

For example in some embodiments this processor may be provided by an end user device such as a smart phone, laptop or personal computer. In other embodiments a processor may be provided by computer based components located remote from the user. In yet other embodiments a processor utilised by the invention may be implemented by a distributed system consisting of a combination of separate hardware elements working together.

Furthermore the processor or processors utilised by the invention may operate with a range of different system architectures. In some embodiments the invention may provide a client application in communication with one or more remote services which together provide a method of information retrieval. Those skilled in the art will appreciate that the various functions executed in accordance with the invention may potentially be undertaken locally on a user accessible device, or with a remote server interacting with a thin client terminal application accessible to users. In yet other instances the processor utilised by the invention may run a client application which engages with peer-to-peer networks for the retrieval of information.

Reference in general throughout this specification will however be made to the information retrieval system provided utilising a client server architecture, with a local client device running instructions to communicate with a remote server or service. Again those skilled in the art will appreciate that other arrangements or configurations of the processor and the instructions it executes are also within the scope of the invention.

The user interface implemented with the invention is arranged to initially solicit domain identity information to begin an information retrieval procedure. Domain identity information can be received from the user for the purposes of identifying a area of subject matter or information of interest to the user. In various instances domain identity information can define a superset of possible information to be retrieved, and can specify an area of interest to a user or a problem which the user wishes to address. In a range of embodiments domain identity information may consist of a natural language phrase, a keyword or keywords characterising the interest of a user, or potentially the selection of an icon or indicator associated with a popular information domain commonly of interest to a number of users.

For example various use cases of domain identity information may be defined by a user supplying natural language phrases or keywords such as ‘home appliance purchase’ or ‘motorcycle maintenance’. Other use cases could for example include a user selection or interaction with a graphical icon presenting the terms ‘find a tradesperson’.

The invention can use the domain identity information provided by a user to identify, retrieve and present domain attribute information to the user. This domain attribute information can act as a higher resolution resource for specifying particular subsets of information related to the domain identified by the user. Domain attribute information may also identify different characteristics or attributes related to the content of the information domain identified by a user.

These domain attributes can potentially expand a user's understanding or awareness of a particular information domain and have the capacity to provide further information or detail which the user may not necessarily be aware of. The presentation of the domain attributes therefore may give a user the ability to characterise the information they are seeking with a higher accuracy or resolution.

In various embodiments domain attribute information may be drawn from prepopulated templates which specify an identified information domain, preferably in terms of a group of subsets of characterising information.

Those skilled in the art will appreciate that the nature or identity of domain attribute information presented by the invention will be directly dictated by the information domain identified by a user. For example in respect of the ‘purchase an appliance’ information domain use case domain attribute information may include attributes such as price, reviews, dimensions, performance specifications and manufacturer identity. As another example the ‘find a tradesperson’ information domain use case domain attribute information may include attributes such as services offered, locations or geography serviced, customer reviews and service prices.

In various embodiments the domain attributes to be presented to a user may be drawn from a stored library of templates related to popular information domains. In other embodiments domain attributes may be generated and presented in real time using artificial intelligence systems to summarise the commonly used attributes of the information domain.

Preferably the invention may encompass the provision of a graphical user interface and domain attributes may be presented concurrently adjacent to one another.

In various embodiments the positioning of the domain attributes may also communicate further information such as an importance, relevance or priority that a specific attribute may have in relation to other attributes of the same information domain. For example in one possible embodiment the attributes of an information domain may be presented to user in a hierarchy or series of steps with the height at which an attribute is presented in the hierarchy indicating a possible relevance or importance to the information domain.

In a number of embodiments a user may interact with the graphical presentation of a domain attribute to trigger the presentation of further information characterising the nature of the attribute. For example in some instances a graphical user interface may allow an icon or representation presented for an attribute to be touched, clicked or activated in a variety of ways. This interaction can prompt the display of further information to a user relating to the attribute being interacted with.

In various embodiments a user may interact with the graphical presentation of a domain attribute to modify the characteristics or scope of that attribute. For example user input may be received to restrict or expand a numerical range related to an attribute based on the user's own preferences. Such interactions could also be exclusionary in nature, identifying that the attribute has minimal relevance to the user's circumstances or preferences. The presentation of domain attribute information can be used to solicit priority indications from a user related to one or more of the domain attributes involved. These priority indications can be used to refine the particular interests or the issues faced by a user relative to the information domain. Priority indications may potentially be used as a weighting or loading mechanism employed by the user to indicate the relative importance or relevance they assign to the various attributes of an information domain. Priority indications may also potentially be used to order various information attributes relative to one another.

In some embodiments priority indications may take the form of a Boolean yes or no indicator, a numeric value, or range of numeric values. Those skilled in the art will also appreciate that in some instances a priority indication may encompass a natural language response from the user to be parsed by an algorithm to result in a numeric or Boolean indicator. In some instances priority indications may also be negative or exclusionary in nature, indicating that the user believes a particular attribute is irrelevant to their current requirements.

However in a range of preferred embodiments the invention may provide a graphical user interface and priority indications may be received through a user interacting with the graphical representation of the attributes presented to them. In further preferred embodiments the relative positioning, orientation or arrangement of the attribute graphics relative to one another may provide the priority indications solicited from the user. In such instances an initial arrangement of attribute graphics may be presented and the user can interact with these graphics to change their positions to indicate relative priority to the user.

For example in one potential embodiment a set of attribute graphics may be presented to a user in a step hierarchy with the attributes being placed in groups in various tiers or steps. A user can be invited to move attributes between the steps of this hierarchy and also modify the order which the attributes are presented within a particular step. These graphical interactions allow a user to visualise the relative importance or priority of all the attributes presented at the same time and relative to one another.

In a number of optional embodiments the information retrieval system may collect an initial set of user priority indications and then subsequently solicit or invite a user to provide a reassigned set of priority indications. For example in some instances this reassigned set of priority indicators may be solicited to confirm with the user their initial choices of priority indications and also allow for modifications to be made to this initial set of choices. This additional process may preferably allow a user to review all their priority indications relative to another and make suitable adjustments in light of having assessed all of the relevant domain attributes.

For example in a preferred embodiment where the positioning of the attribute graphics identify their relative priorities this collection of reassigned priority indications is made readily available to users. A user can arrange the attribute graphics in any acceptable way, consider this arrangement and then make further refinements or reassignments as desired.

The invention uses the plurality of priority indications—or a set of reassigned priority indications—to assemble result information.

In preferred embodiments the result information to be assembled may consist of collections of individual records relating to internet published information. One such record may have or be associated with at least one domain attribute specified for the related information domain of interest to a user. Preferably each record to be assembled may be associated with a plurality of the domain attributes for which the user has provided priority indications. These discrete records may be identified and formatted for subsequent presentation to a user.

In various embodiments a record provided as part of the result information may consist of an internet address for a specific page or pages. In other instances a single record may draw information from a variety of internet addresses or pages from different website domains. In yet other instances a record may be drawn from information stored in an internet connected database created to provide information specific to a particular information domain.

Preferably result information may be assembled by initially identifying a set of possible records which exhibits the domain attributes prioritised by a user. Preferably these records may be sourced from internet published records. This set of possible records may then be ranked or scored for relevance by analysing the values or character of each record's domain attributes and comparing these with the related priority indications received from a user.

For example in one possible embodiment each potentially relevant record drawn from a set of results may have a relevance score calculated. A variety of functions may be employed which receive as inputs the record attribute information and associated received priority indications. In one particular embodiment a weighted sum function may be used where a numeric value representing each a specific attribute can be multiplied by a numeric value received as a related priority indication. High value priority indications can therefore increase the relevance score of a particular result when associated with an attribute which also has a high numeric value.

In various additional embodiments a weighting process may be executed on the values of the attribute information used for each record. For example this weighting process may preferably be undertaken prior to the calculation of a relevance score and may be completed in relation to attributes incorporating a range of numeric values when a user has previously specified an optimum or desired range. In such embodiments this weighting process may apply a single numeric value in relation to an attribute, with the value applied being dictated by whether the attribute is inside of or displaced from the user-specified range. In such embodiments the weighted attribute information can then be subsequently used in the calculation of a relevance score substantially as described above.

In various embodiments the invention may preferably use a relevance score applied to a set of possible results to rank or order the set of results. The ranked or ordered records making up this result information can then be presented to a user.

Those skilled in the art will however appreciate that alternative methods and processes for the assembly of result information may also be used in other embodiments and are within the scope of the invention.

For example in one embodiment machine learning technologies may be used to generate a collection of machine learning ranking models for a domain identity. One of the machine learning ranking models may be selected for use based on the priority indications received from a user, with the selected model being supplied with the received priority indications to produce a set of ranked results.

In one particular embodiment XGBoost (extreme Gradient Boosting, https://en.wikipedia.org/wiki/XGBoost https://github.com/dmlc/xgboost) may be used. The XGBoost library may be trained on an information resource providing a possible set of result information records to produce decision tree models for various possible combinations of weighted input priorities. A particular model may be selected for use based on priority indications received from a user, with the selected model being supplied with the received priority indications. The model can then be applied to the source information resource to produce a set of ranked results.

In preferred embodiments the result information presented to users may be formatted using at least one of the priority indications received from the user.

In some embodiments this result information may simply consist of a list of links to webpage addresses where the uses priority indications and the information published at each address determines the order in which these records are presented as result information.

In other embodiments the records making up result information may also display information related to at least one of the domain attributes related to the record. In such embodiments the priority indications received from a user may be used to format how a record is displayed, with domain attributes bring presented in the order of highest to lowest user priority indications. This approach may therefore result in result records being presented in an order dictated by the relevance of the record to the user's priority indications, with the internal content of the record also being formatted or presented in accordance with these same priority indications.

In various further embodiments records may be presented adjacent to one another to allow for easy comparison the records considered to have similar relevance to the user's priority indications. This graphical comparison approach allows users to easily assess the most important attributes of each record to the needs and potentially select one record over another for further assessment.

In various embodiments one or more of the records presented as result information may be interacted with by a user to trigger the presentation of additional information. For example, in some embodiments a graphical representation of a record may be selected, ‘double clicked’ or otherwise identified by a user to trigger the display of further information pertinent to the record. These user interactions can for example retrieve further information or the entire contents of a record or potentially present additional internet address information identifying where further information can be retrieved.

The present invention may provide many potential advantages over the prior art.

Through its various aspects the invention can allow a user to retrieve pertinent and relevant result information with little to no background in or understanding of a related information domain.

The invention can operate to provide a user with a set of characterising attributes for an information domain they have no familiarity with, and can solicit feedback from the user on the relative importance or priority of specific attributes to their current objectives. This approach can provide a user with a clear overview of an information domain and allow them to navigate the intricacies of same to obtain relevant information.

In various embodiments the invention can be used to compile an initial set of priority indications related to various attributes of an information domain, and then subsequently allow a user to revise or reassign these the priorities once they have considered all relevant attributes of the information domain. This approach ensures that users gain a better understanding or insights into a specific information domain.

This approach drives the user to consider, prioritise, and trade-off all attributes of potential relevance while also visually informing them of the information pertinent to their circumstances.

### BRIEF DESCRIPTION OF THE DRAWINGS

Additional and further aspects of the present invention will be apparent to the reader from the following description of embodiments, given in by way of example only, with reference to the accompanying drawings in which:

FIG. 1.1 to 1.6 show elements of an example graphical user interface provided by the invention in one embodiment and illustrate user interactions with this interface,

FIG. 1.7 to 1.9 show elements of the same graphical user interface illustrated by FIG. 1.1 to 1.6 and illustrate a further user interactions with this interface,

FIG. 1.10 to 1.15 again show elements of the same graphical user interface illustrated by FIG. 1.1 to 1.9 and illustrate another set of user interactions with this interface,

FIG. 2.1 to 2.4 provide input parameter information and flowcharts for steps executed to retrieve result information in the embodiment illustrated by FIG. 1.1 to 1.15,

FIG. 2.5 shows an example presentation of result information to the user by the graphical user interface provided in accordance with FIG. 1.1 to 2.4,

FIG. 3.1 to 3.6 show elements of an example graphical user interface provided in a further embodiment and illustrate user interactions with this interface,

FIG. 4.1 to 4.5 show elements of an example graphical user interface provided in another embodiment and illustrate user interactions with this interface,

FIG. 5.1 to 5.4 show elements of an example graphical user interface provided in yet another embodiment and illustrate user interactions with this interface,

FIG. 6.1 to 6.5 show elements of an example graphical user interface provided in an additional embodiment and illustrate user interactions with this interface,

FIG. 7.1 to 7.11 show elements of an example graphical user interface provided in another embodiment and illustrate user interactions with this interface,

FIG. 8.1 to 8.8 show elements of an example graphical user interface provided in an yet additional embodiment and illustrate user interactions with this interface,

FIG. 9.1 to 9.5 provide input parameter information and flowcharts for steps executed to retrieve result information accordance to an alternative embodiment to that shown in relation to FIG. 2.1 to 2.4 Further aspects of the invention will become apparent from the following description of the invention which is given by way of example only of particular embodiments.

### BEST MODES FOR CARRYING OUT THE INVENTION

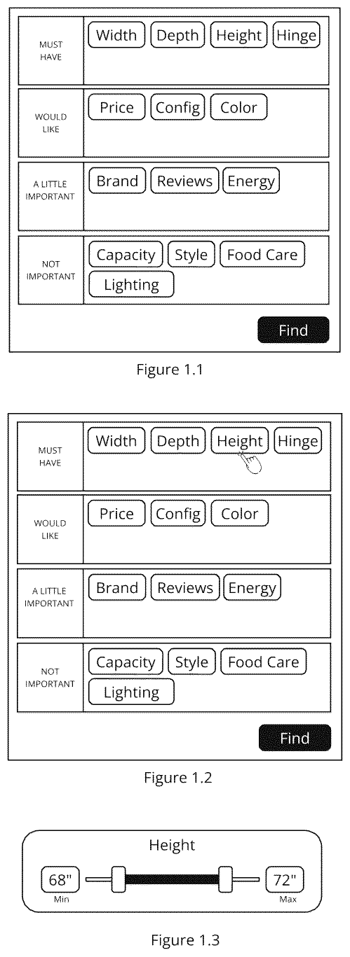

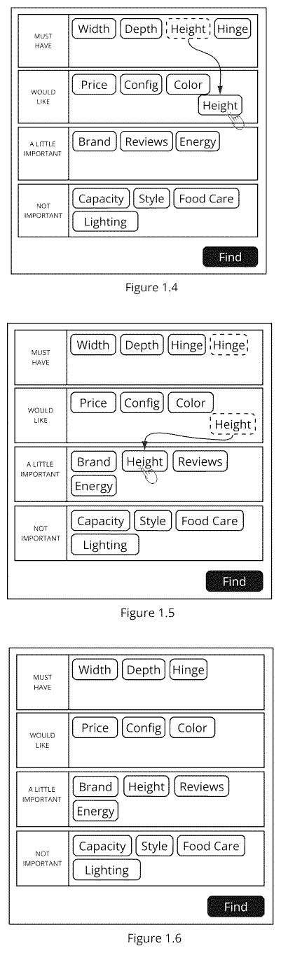

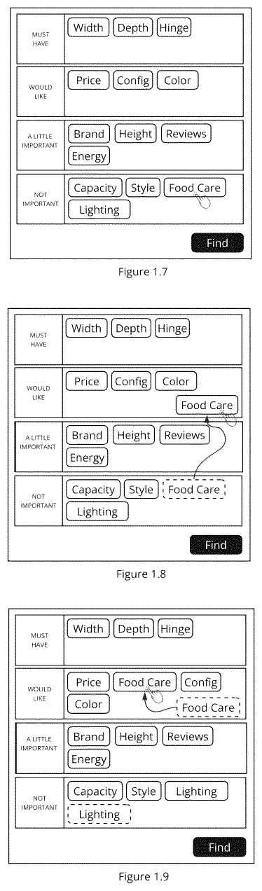

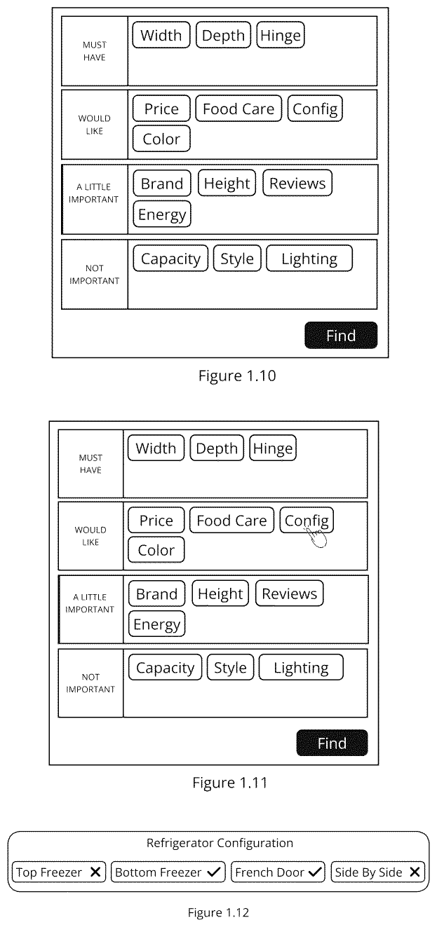

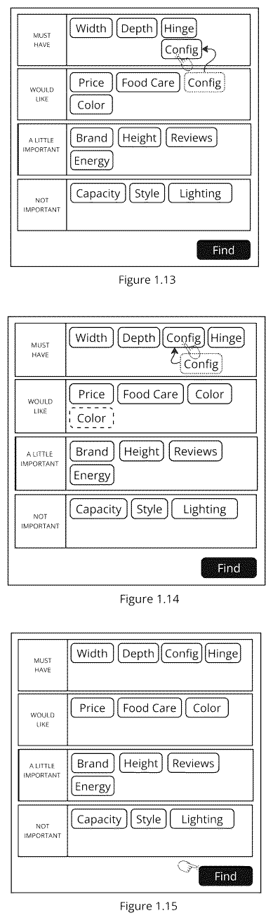

FIG. 1.1 to 1.6 show elements of an example graphical user interface provided by the invention in one embodiment and illustrate user interactions with this interface.

FIG. 1.1 shows the initial presentation of domain attribute information to a user which occurs after a user has provided the user interface with domain identity information. In the circumstances shown with respect to FIG. 1.1 the user has previously supplied the domain information “household refrigerator purchase”.

As shown by FIG. 1.1 the user is initially presented with 14 instances of domain attribute information, arranged in 4 groups in priority order from highest priority (“Must Have”) to lowest priority (“Not Important”). Domain attributes are then arranged in priority order within each group. Each attribute is displayed in a tile. The order of the tiles can be changed by the user dragging and dropping the tile (e.g. using a touchscreen or mouse device) to change the priority order, as discussed in further detail below.

FIG. 1.2 shows a subsequent user interaction with the interface of FIG. 1.1 where the user decides that the “Height” attribute is a priority to them, so they click the “Height”tile.

As shown in FIG. 1.3 the user can additionally set a range for the “Height” attribute. In this case the user prioritises a height between 68 and 72 inches.

In FIG. 1.4 the user considers the priorities indicated by the spatial arrangement of the attribute tiles and decides that “Height” is something that is a little important, but it is a lower priority for them than some other attributes. The user starts dragging the “Height” tile from its current position.

In FIG. 1.5 the user completes the drag and drop operation by moving the “Height” tile to its new position (in the “A little more important” group, between “Brand” and “Reviews”) and then releasing their click. The remaining tiles maintain their order but move to allow the “Height” tile to assume its new position.

In FIG. 1.6 we can see the currently considered priorities that the user has chosen.

FIG. 1.7 to 1.9 show elements of the same graphical user interface illustrated by FIG. 1.1 to 1.6 and illustrate further user interactions with this interface. These interactions occur with the interface in the initial state shown with respect to FIG. 1.6

As shown by FIG. 1.7 the user again reviews the priority indications represented by the spatial positioning of the domain attribute tiles and decides that “Food Care” is a higher priority for them, so the user clicks and holds the “Food Care” tile. In FIG. 1.8 the user starts to drag the “Food Care”tile from its current priority to a higher priority.

In FIG. 1.9 the user completes the drag and drop operation by moving the “Food Care” tile to its new position (in the “Would Like” group, between “Price” and “Config”) and then releasing their click. The remaining tiles maintain their order but move to allow the “Food Care” tile to assume its new position.

From FIG. 1.10 we now can see the currently considered priorities that the user has chosen. In FIG. 1.11 the user again reviews the priorities and decides that “Config” is a priority for them, so the user clicks the “Config” tile.

As shown in FIG. 1.12 the user can additionally set a range for the “Config” attribute. In this case the user is presented with four possible refrigerator configurations. The user prioritises the Config attribute to include “Bottom Freezer”and “French Door”refrigerators over the other options.

In FIG. 1.13 the user again reviews the priorities and decides that “Config” is a must have priority for them, so the user clicks and holds the “Config” tile.

In FIG. 1.14 the user completes the drag and drop operation by moving the “Config” tile to the third position in the “Must Have” priorities (after “Depth” and before “Hinge”) and then releasing their click. The remaining tiles maintain their order but move to allow the “Config” tile to assume its new position.

In FIG. 1.15 the user, who is now happy with the priority indications they have provided, clicks the find button. This constructs a message containing information about the attributes and priority indications the user has chosen to be transmitted to the priority ranking engine.

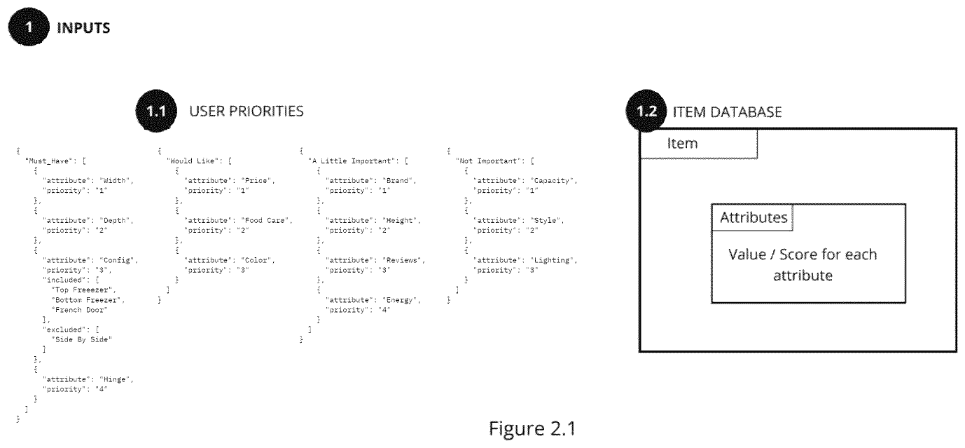

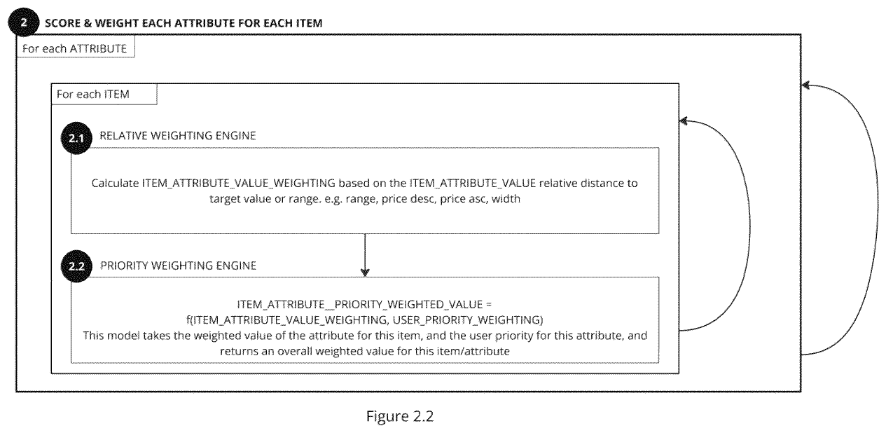

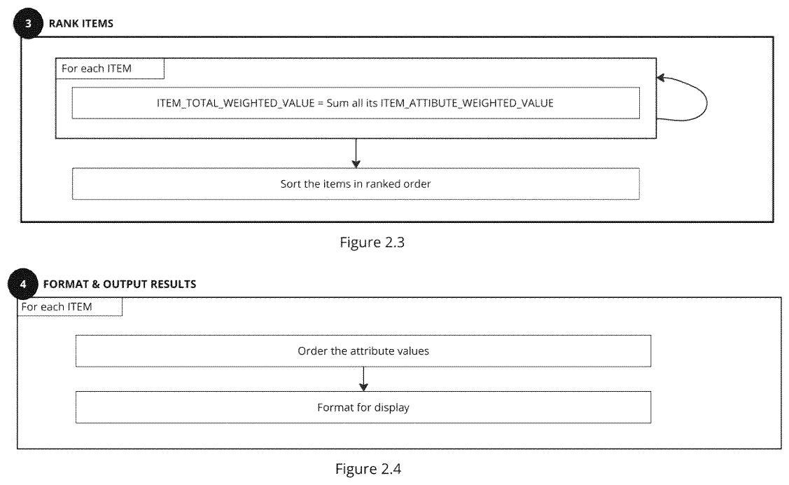

FIG. 2.1 to 2.4 provide input parameter information and flowcharts for steps executed to retrieve result information in the embodiment illustrated by FIG. 1.1 to 1.15. FIG. 2.1 to 2.14 exemplify the operation of a priority ranking engine used in this embodiment of the invention. FIG. 2.5 also shows an example presentation of result information to the user by the graphical user interface provided in accordance with FIG. 1.1 to 2.4,

In particular FIG. 2.1 shows an example of the first step taken by the priority ranking engine. In this case there are two inputs. The first is the user priority indications [1.1]. The second is an item database [1.2]. In this case, the item database contains information on all available refrigerators.

Each refrigerator has a value, and a score calculated for each instance of domain attribute information.

FIG. 2.2 shows the second operational step executed by the priority ranking engine. For each attribute, the engine steps through each item (in this case refrigerators) and calculates:
2.1: A weighting of the attribute value based on the relative distance to either the priority target value the user has chosen or relative to other products. E.g. in this example the user has prioritised a “Height” between 68 and 72 inches, so the weighting for each “Height” attribute will be calculated relative to this. The user has also prioritised “Price”, so the weighting for each “Price” attribute will be calculated relative to the “Price” attribute of all other refrigerators.
2.2: Each item is then scaled using the weighted value calculated in step 2.1, and the user priorities received in the input message. This will return an overall weighting for this attribute on this product item relative to other product items.

FIG. 2.3 shows the third operational step of the priority ranking engine.

For each item (e.g. in this case each refrigerator) it sums all the weighted priorities for all of its attributes. It then sorts and ranks all the refrigerators by this total weighting, giving a list of refrigerators ranked by the users'specific priorities.

FIG. 2.4 shows the fourth operational step of the priority ranking engine.

The priority ranking engine returns the ranked results, with products prioritised according to the users'priorities, and displaying the actual attribute values for each product in the same order that the user chose.

FIG. 2.5 shows how these items of result information are presented to the user in this embodiment. The refrigerators are clearly ranked in priority order for the user. Because the user has specified the priority order of the attributes they require, the attributes are displayed in the same priority order. The makes the results immediately easier for the user to digest, due to the most important attributes to the user being displayed first. This approach also eliminates the need for further sorting or filtering options to be executed on the results by the user.

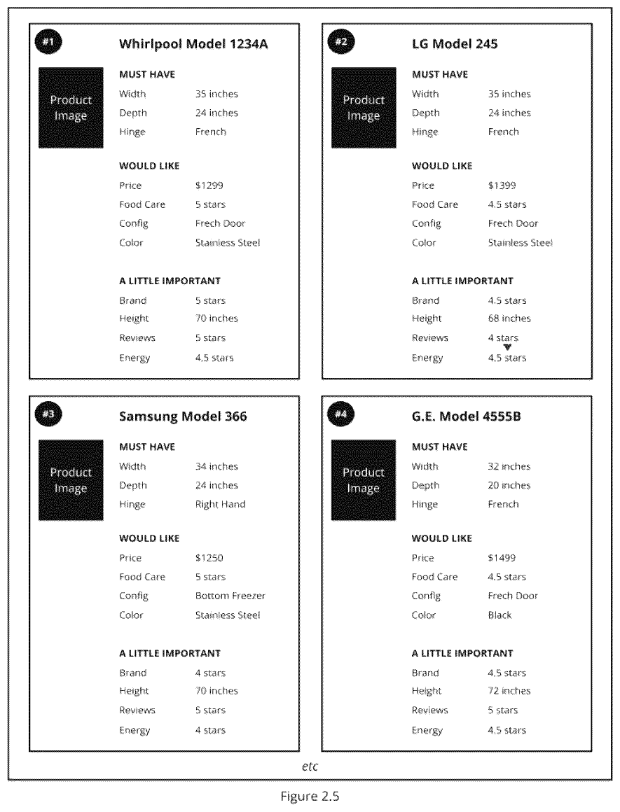

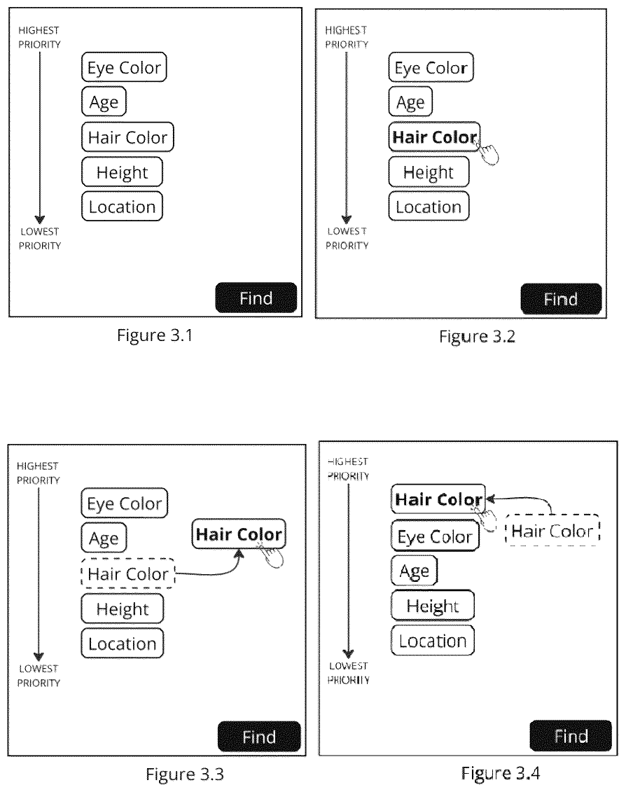

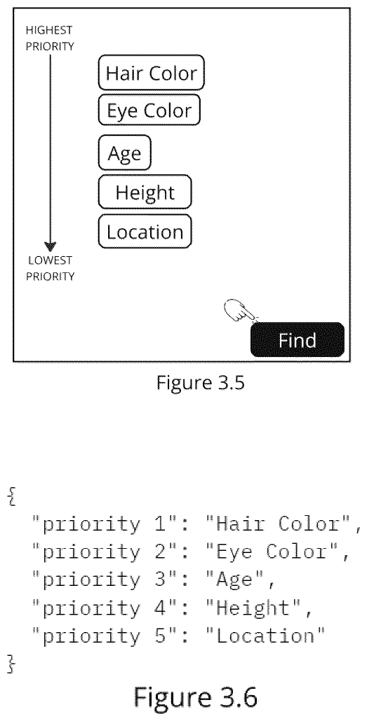

FIG. 3.1 to 3.4 show elements of an example graphical user interface provided in a further embodiment and illustrate user interactions with this interface. In this implementation, the user wants to find a partner ranked by the user's preferences through previously specifying domain identity information of the form ‘Find a romantic partner’.

From FIG. 3.1 the user is first presented with five instances of domain attribute information (“Eye Color”, “Age”, “Hair Color”, “Height”, “Location”), positioned in an initial default ranking from highest Priority to lowest Priority. Each attribute is displayed in a tile. The order of the tiles can be changed by the user dragging and dropping the tile to change the priority order.

In FIG. 3.2 the user decides that “Hair Color” is the most important attribute to them. They click and hold the “Hair Color” tile. In FIG. 3.3 the user starts dragging the “Hair Color”tile from its current position.

In FIG. 3.4 the user completes the drag and drop by moving the “Hair Color” tile to the top (highest priority) position and then releasing their click. The remaining tiles maintain their order but move down to allow the “Hair Color”tile to assume the highest priority position.

In FIG. 3.5 the user, who is now happy with the priority order they have chosen, clicks the find button. This constructs a message containing information about the attributes and priority the user has chosen that can be submitted to a priority ranking engine that can use this information as input to then return result information. In FIG. 3.6 a simple example message structure for this example is shown. This is submitted to a priority ranking engine.

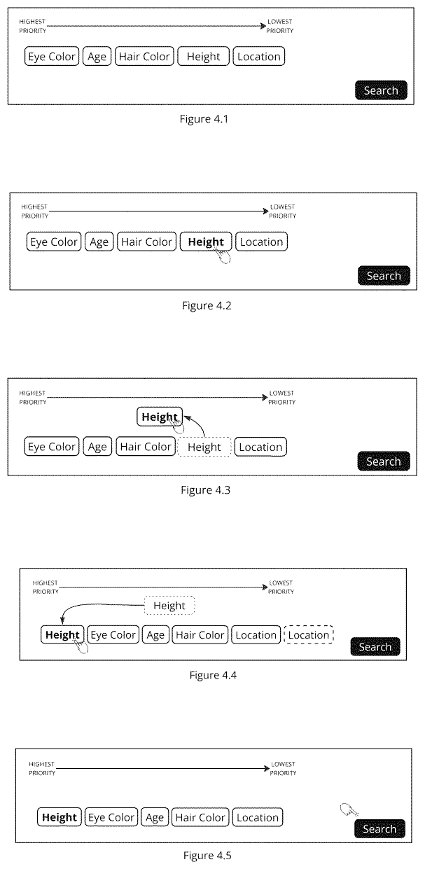

FIG. 4.1 to 4.5 show elements of an example graphical user interface provided in another embodiment and illustrate user interactions with this interface. In this implementation, the user again wants to find a partner ranked by the user's preferences through previously specifying domain identity information of the form ‘Find a romantic partner’.

This is a similar implementation to that shown in relation to FIG. 3.1 to 3.6, however in this case the tiles are arranged horizontally to determine priority.

In FIG. 4.1 the user is first presented with five instances of domain attribute information (“Eye Color”, “Age”, “Hair Color”, “Height”, “Location”), with an initial ranking from highest priority to lowest priority. Each attribute is displayed in a tile. The order of the tiles can be changed by the user dragging and dropping the tile to change the priority order.

In FIG. 4.2 the user decides that “Height” is the most important attribute to them. They click and hold the “Height” tile. In FIG. 4.3 the user starts dragging the “Height”tile from its current position.

In FIG. 4.4 the user completes the drag and drop operation by moving the “Height” tile to the first position (highest priority) position and then releasing their click. The remaining tiles maintain their order but move to allow the “Height”tile to assume the highest priority position.

In FIG. 4.5 the user, who is now happy with the priority order they have chosen, clicks the search button. This constructs a message containing information about the attributes and priority indications the user has chosen that can be submitted to a priority ranking engine as input to then return result information.

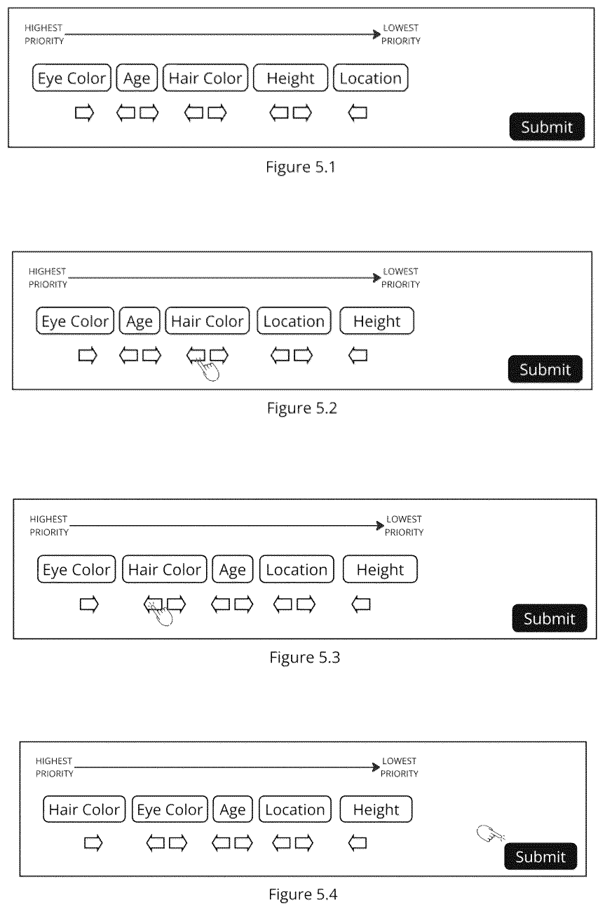

FIG. 5.1 to 5.4 show elements of an example graphical user interface provided in yet another embodiment and illustrate user interactions with this interface. In this implementation, the user again wants to find a partner ranked by the user's preferences through previously specifying domain identity information of the form ‘Find a romantic partner’. In this instance the user provides priority information for domain attributes by using the arrow icons shown to modify the spatial positioning of attribute information tiles In FIG. 5.1 the user is first presented with five instances of domain attribute information (“Eye Color”, “Age”, “Hair Color”, “Height”, “Location”), with an initial ranking from highest priority to lowest priority. Each attribute is displayed in a tile. The order of the tiles can be changed by the clicking one of the arrow icons to move the tile up or down in priority.

In FIG. 5.2 the user decides that “Hair Color” is a more important attribute to them. They click the left arrow below the “Hair Color” tile. In FIG. 5.3 the “Hair Color” tile has now moved up in priority. The user decides that “Hair Color” is still a more important attribute to them. They again click the left arrow below the “Hair Color”tile.

In FIG. 5.4 the “Hair Color” tile has now moved into the highest priority position. The user, who is now happy with the priority order they have chosen, clicks the submit button. This constructs a message containing information about the domain attributes and priority information the user has chosen that can be submitted to a priority ranking engine as input to return result information.

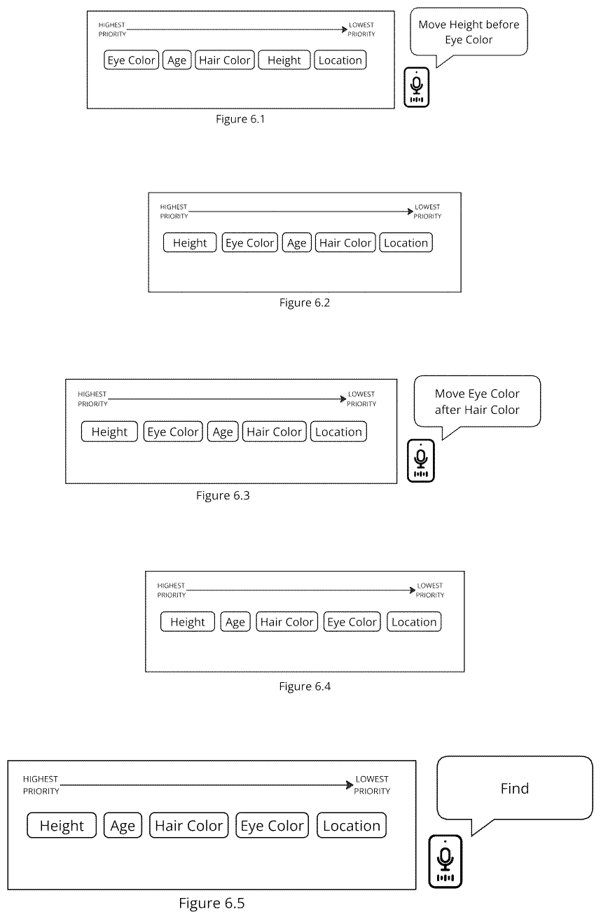

FIG. 6.1 to 6.5 show elements of an example graphical user interface provided in an additional embodiment and illustrate user interactions with this interface. In this implementation, the user again wants to find a partner ranked by the user's preferences through previously specifying domain identity information of the form ‘Find a romantic partner’. In this instance the user provides priority information for domain attributes by using voice commands.

Again as shown by FIG. 6.1 the user is first presented with five instances of domain attribute information (“Eye Color”, “Age”, “Hair Color”, “Height”, “Location”), with an initial ranking from highest priority to lowest priority.

Each attribute is displayed in a tile. The order of the tiles can be changed by the user using voice commands.

From FIG. 6.1 the user decides that “Height”is more important to them. They issue the voice command “Move height before eye color”. In FIG. 6.2 the “Height”tile has now moved up in priority before “Eye Color”.

In FIG. 6.3 the user decides that “Eye Color” is less important attribute to them. They issue the voice command “Move eye color after hair color”. In FIG. 6.4 the “Eye Color” tile has now moved down in priority after “Hair Color”.

In FIG. 6.5 the user, who is now happy with the priority order they have chosen, issues the voice command “Find”. This constructs a message containing information about the attributes and priority the user has chosen that can be submitted to the priority ranking engine as input to return result information.

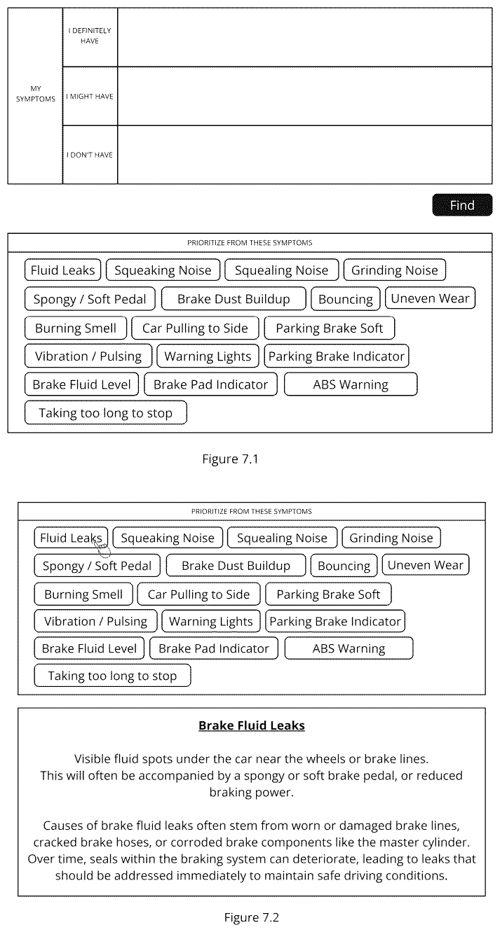

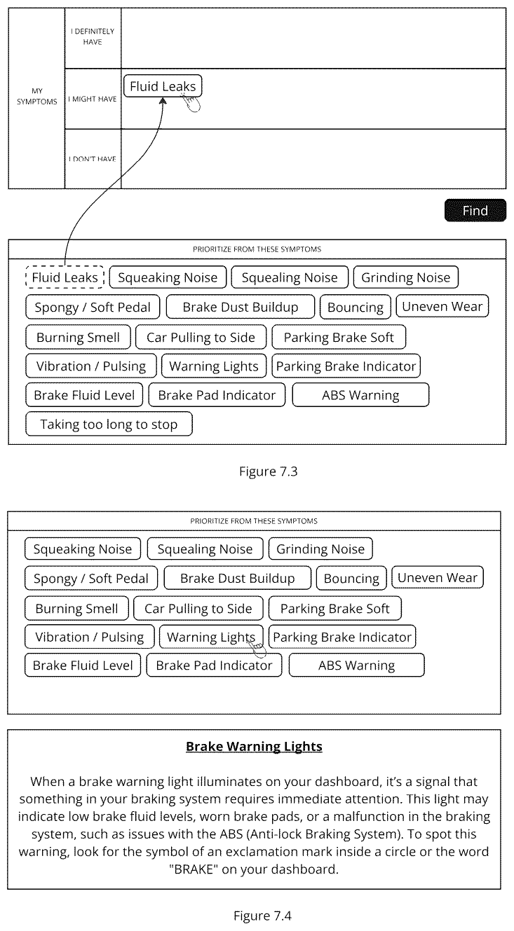

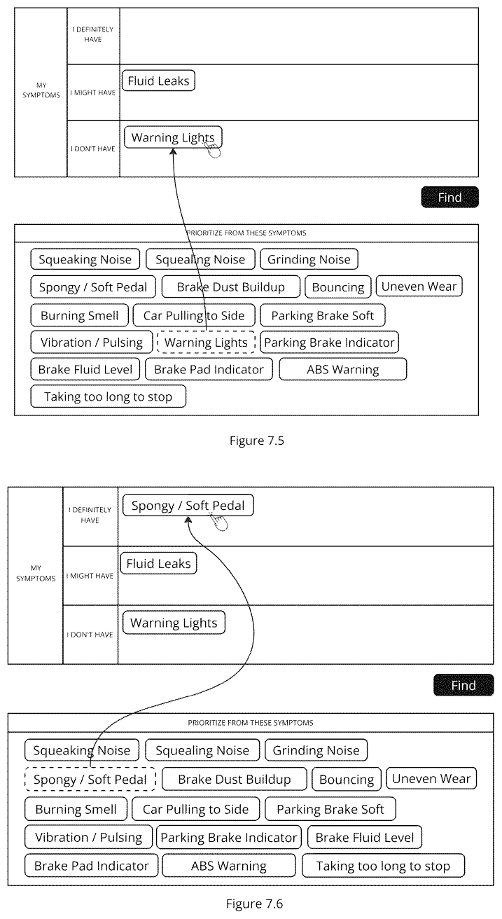

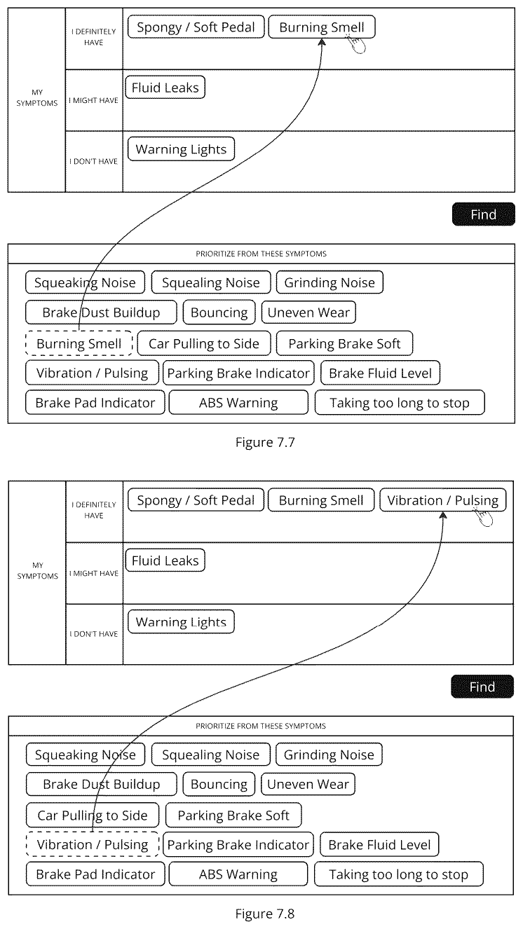

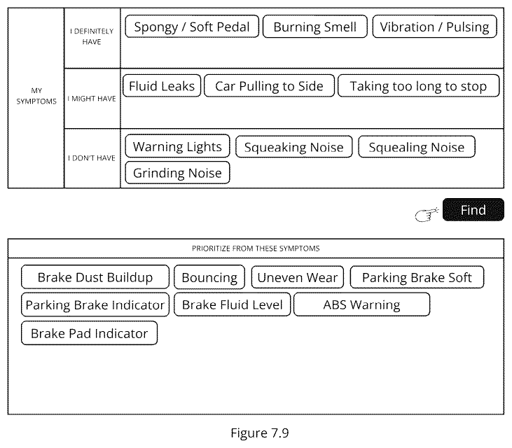

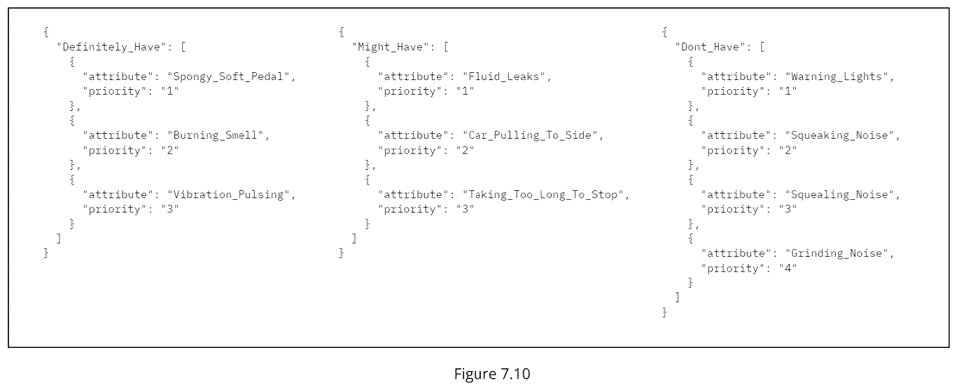

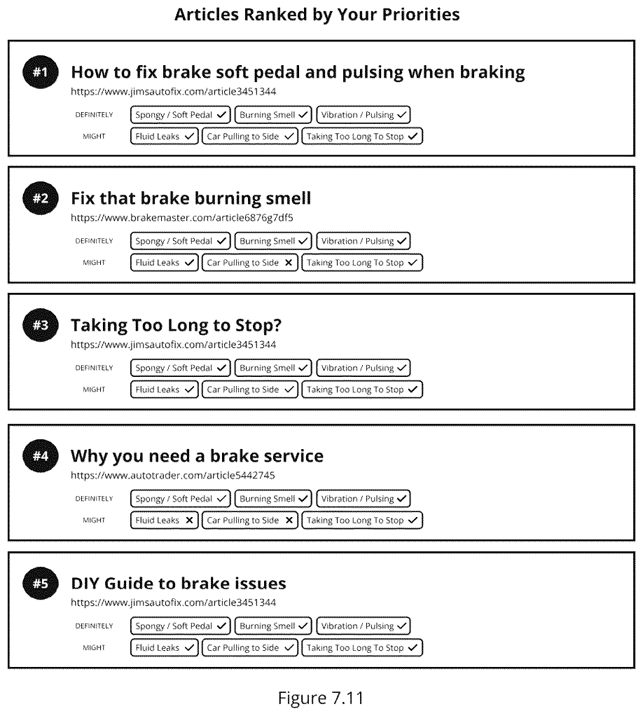

FIG. 7.1 to 7.11 show elements of an example graphical user interface provided by the invention in another embodiment and illustrate user interactions with this interface.

FIG. 7.1 shows the initial presentation of domain attribute information to a user which occurs after a user has provided the user interface with domain identity information. In the circumstances shown with respect to FIG. 7.1 the user has previously supplied the domain information “How do I fix my cars brakes?”.

As shown by FIG. 7.1 the user is initially presented with 18 instances of domain attribute information. There are three groups available for the user to prioritise their own personal circumstances. These are arranged in priority order from highest priority (“I Definitely Have”) to lowest priority (“I Don't Have”). Domain attributes can then be arranged in priority order within each group. Each attribute is displayed in a tile. The order of the tiles can be changed by the user dragging and dropping the tile (e.g. using a touchscreen or mouse device) to change the priority order, as discussed in further detail below.

FIG. 7.2 shows a subsequent user interaction with the interface of FIG. 7.1 where the user decides that they would like more information on “Fluid Leaks”. The user clicks on the “Fluid Leaks” tile and information they need to consider about “Brake Fluid Leaks”is displayed.

In FIG. 7.3 the user considers the priorities indicated by the spatial arrangement of the attribute tiles and decides that “Fluid Leaks” is something that they may have. The user drags the “Fluid Leaks” tile from the possible attributes into the “I Might Have”priority group.

In FIG. 7.4 the user decides that they would like more information on “Warning Lights”. The user clicks on the “Warning Lights” tile and information they need to consider about “Brake Warning Lights” is displayed.

In FIG. 7.5 the user considers the priorities indicated by the spatial arrangement of the attribute tiles and decides that “Warning Lights” is something that they definitely do not have. The user drags the “Warning Lights” tile from the possible attributes into the “I Don't Have” priority group.

In FIG. 7.6 the user considers the priorities indicated by the spatial arrangement of the attribute tiles and decides that “Spongy/Soft Pedal” is something that they definitely have. The user drags the “Spongy/Soft Pedal” tile from the possible attributes into the “I Definitely Have” priority group.

In FIG. 7.7 the user considers the priorities indicated by the spatial arrangement of the attribute tiles and decides that “Burning Smell” is something that they definitely have. The user drags the “Burning Smell” tile from the possible attributes into the “I Definitely Have”priority group.

In FIG. 7.8 the user considers the priorities indicated by the spatial arrangement of the attribute tiles and decides that “Vibration/Pulsing” is something that they definitely have. The user drags the “Vibration/Pulsing” tile from the possible attributes into the “I Definitely Have”priority group.

FIG. 7.9 shows the arranged user priorities once the user has completed arranging the attribute tiles according to their considered priorities. The user, who is now happy with the priority indications they have provided, clicks the find button. This constructs a message containing information about the attributes and priority indications the user has chosen to be transmitted to the priority ranking engine.

In FIG. 7.10 an example message structure for this set of user priorities is shown. This is submitted to a priority ranking engine.

In FIG. 7.11 an example of the results returned to the user is shown. In this case there links to five articles relevant to the users priorities. A URL link is provided that the user can click on to go to that web URL. For each article, the attribute priorities the user requested are shown in order, with a graphical indication of how relevant the article is for each attribute.

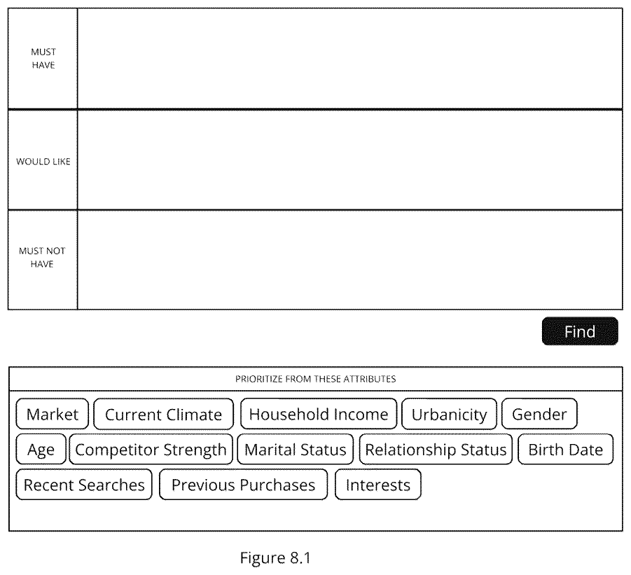

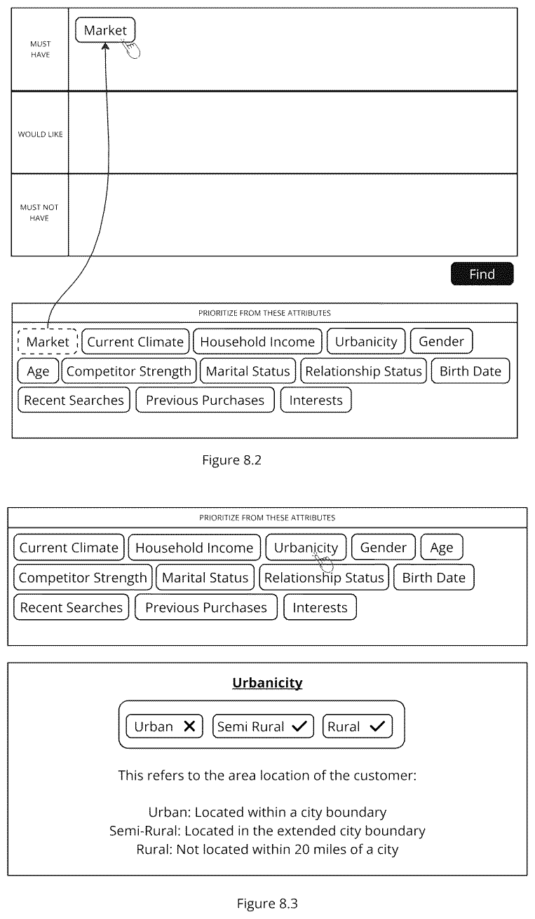

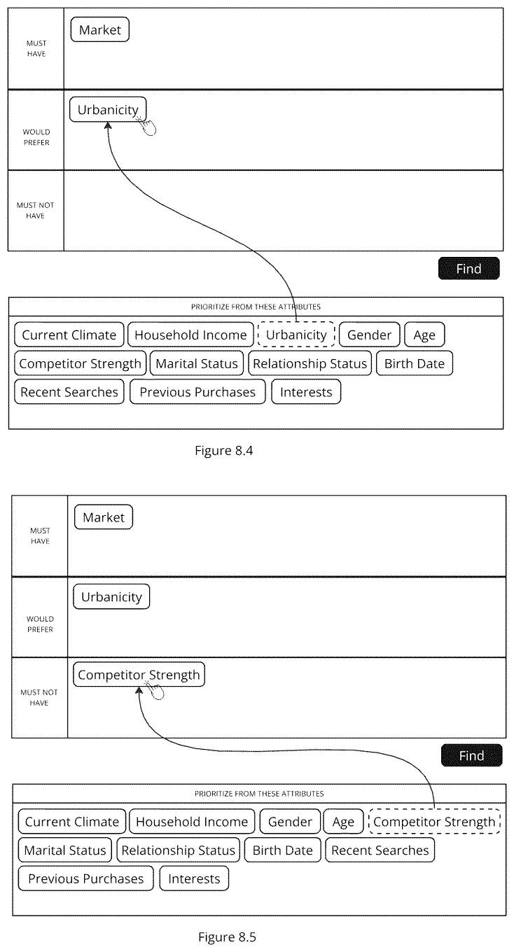

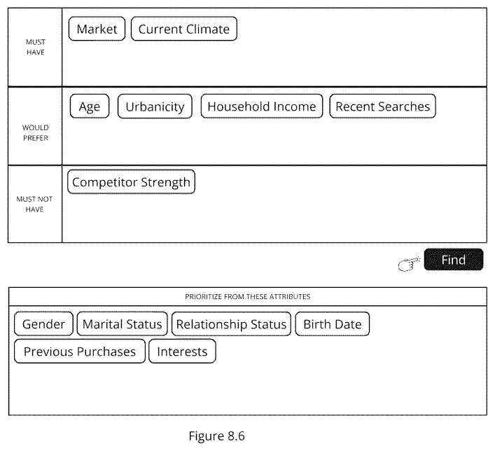

FIG. 8.1 to 8.8 show elements of an example graphical user interface provided by the invention in yet another embodiment and illustrate user interactions with this interface.

In this embodiment the invention is deployed in a marketing automation application across internal company or organisation data. The intent of the application in this embodiment is to allow the user to prioritise customers according to attribute priorities, and then return a list of ranked customers to the user.

FIG. 8.1 shows the initial presentation of domain attribute information to a user which occurs after a user has provided the user interface with domain identity information. In the circumstances shown with respect to FIG. 8.1 the user is in the marketing team for a sporting goods company and has previously supplied the domain information “Prioritise the top 100 customers for Spring hunting gear offer”.

As shown by FIG. 8.1 the user is initially presented with 13 instances of domain attribute information. There are 3 groups available for the user to prioritise the priorities they have to select customers. These are arranged in priority order from highest priority (“Must Have”) to lowest priority (“Must Not Have”). Domain attributes can then be arranged in priority order within each group. Each attribute is displayed in a tile. The order of the tiles can be changed by the user dragging and dropping the tile (e.g. using a touchscreen or mouse device) to change the priority order, as discussed in further detail below.

In FIG. 8.2 the user considers the priorities indicated by the spatial arrangement of the attribute tiles and decides that “Market” is something that they must have. The user drags the “Market” tile from the possible attributes into the “Must Have”priority group.

In FIG. 8.3 the user decides that they would like more information on “Urbanicity”. The user clicks on the “Urbanicity” tile and information they need to consider about “Urbanicity” is displayed. The user is able to click on the “Urban”, “Semi Rural”, or “Rural” sub-attribute tiles to choose to select or de-select them from their priorities. In this case the user de-selects “Urban”.

In FIG. 8.4 the user considers the priorities indicated by the spatial arrangement of the attribute tiles and decides that “Urbanicity” is something that they would prefer. The user drags the “Urbanicity” tile from the possible attributes into the “Would Prefer”priority group.

In FIG. 8.5 the user considers the priorities indicated by the spatial arrangement of the attribute tiles and decides that “Competitor Strength” is something that the customer must not have. The user drags the “Competitor Strength” tile from the possible attributes into the “Must Not Have” priority group.

FIG. 8.6 shows the arranged user priorities once the user has completed arranging the attribute tiles according to their considered priorities. The user, who is now happy with the priority indications they have provided, clicks the find button. This constructs a message containing information about the attributes and priority indications the user has chosen to be transmitted to the priority ranking engine.

In FIG. 8.7 an example message structure for this set of user priorities is shown. This is submitted to a priority ranking engine.

In FIG. 8.8 an example of the results returned to the user is shown. In this case the top four customers relevant to the users priorities are shown. For each customer, the attribute priorities the user requested are shown in order, along with the actual information for each attribute.

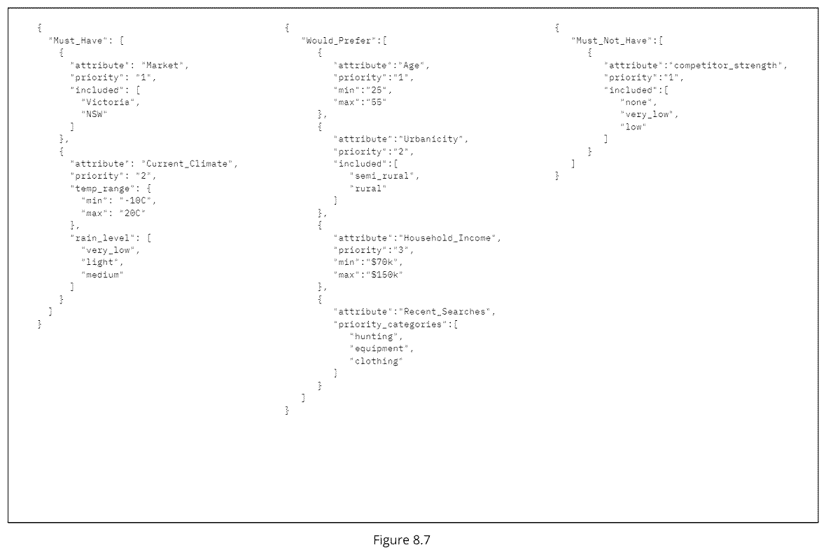

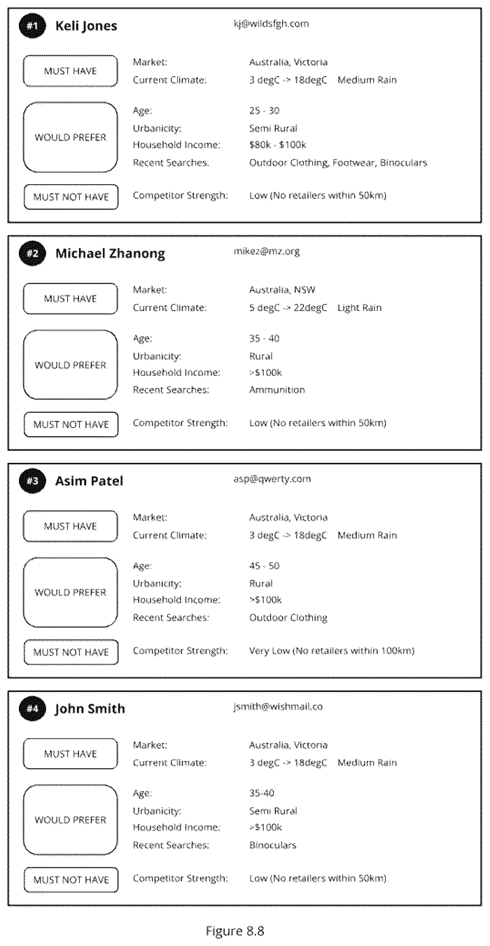

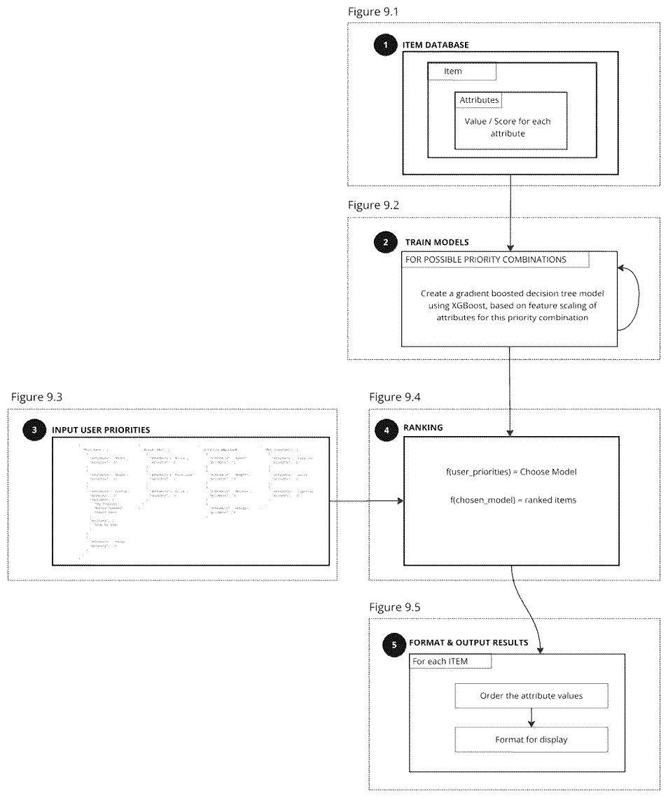

FIG. 9.1 to 9.5 provide input parameter information and flowcharts for steps executed to retrieve result information accordance to an alternative embodiment to that shown in relation to FIG. 2.1 to 2.4 In this embodiment a Learning to Rank machine learning approach is used that constructs a ranking model using training data such that the model can sort objects according to their degrees of relevance, preference, or importance. In this implementation XGBoost (extreme Gradient Boosting, https://en.wikipedia.org/wiki/XGBoost https://github.com/dmlc/xgboost) a popular open-source machine learning library is used. The XGBoost library is trained to produce decision tree models for possible combinations of weighted input priorities.

In particular, FIG. 9.1 to 9.5 shows alternative steps executed to retrieve result information to that of the embodiment referenced above in relation to FIG. 2.1 to 2.4.

In FIG. 9.1 we see an item database acting as an information source for result information. In this case, the item database contains information about the attribute values for each item or record it stores.

In FIG. 9.2 we train decision tree models using XGBoost. Feature scaling (more weight to specific features) and feature selection (features to include or exclude) are used to tune the models. The output from this training is available as a ranking model. This results in a set of ranking models, each tuned to different combinations of possible user priority indications.

In FIG. 9.3 we receive the users selected priorities as inputs as an equivalent step to that shown previously in relation to FIG. 2.1

In FIG. 9.4 we determine the correct ranking model to use based on the users inputs. This is the model most closely aligned with the user priority indications. We then input the users selected priorities into the ranking model. The ranking model returns the ranked items based on the users priorities.

In FIG. 9.5 we format the ranked items by ordering the attribute values based on the users input priorities, and then format the results for display. Results then can be displayed to the user in an equivalent manner to that illustrated in relation to FIG. 2.5.

In the preceding description and the following claims the word “comprise” or equivalent variations thereof is used in an inclusive sense to specify the presence of the stated feature or features. This term does not preclude the presence or addition of further features in various embodiments.

It is to be understood that the present invention is not limited to the embodiments described herein and further and additional embodiments within the spirit and scope of the invention will be apparent to the skilled reader from the examples illustrated with reference to the drawings. In particular, the invention may reside in any combination of features described herein, or may reside in alternative embodiments or combinations of these features with known equivalents to given features. Modifications and variations of the example embodiments of the invention discussed above will be apparent to those skilled in the art and may be made without departure of the scope of the invention as defined in the appended claims.

1. A non-transitory computer-readable storage medium configured to store instructions, the instructions when executed by a processor of an information retrieval system cause the information retrieval system to:
generate a graphical user interface (GUI) configured to:
solicit domain identity information from a user,
present domain attribute information to the user,
solicit from the user priority indications related at least one domain attribute presented to the user,
assemble result information using a set of priority indications received from the user, and
present result information to the user formatted using at least one received priority indication.

2. The non-transitory computer-readable storage medium of claim 1, wherein the processor is provided by an end user device including a smart phone, laptop or personal computer.

3. The non-transitory computer-readable storage medium of claim 2, wherein domain identity information received from the user identifies an area of subject matter of interest to the user.

4. The non-transitory computer-readable storage medium of claim 1, wherein domain identity information consists of a natural language phrase, a keyword or keywords characterising the interest of a user, or the selection of an icon or indicator associated with an information domain.

5. The non-transitory computer-readable storage medium of claim 1, wherein domain attribute information identifies different attributes related to the content of the information domain identified by a user.

6. The non-transitory computer-readable storage medium of claim 1, wherein domain attribute information is drawn from prepopulated templates which specify an identified information domain.

7. The non-transitory computer-readable storage medium of claim 1, wherein a user interacts with the graphical presentation of a domain attribute to modify the characteristics of that attribute.

8. The non-transitory computer-readable storage medium of claim 1. wherein priority indications are received through a user interacting with a graphical representation of domain attribute information presented to them.

9. The non-transitory computer-readable storage medium of claim 8 wherein the relative positioning or orientation of the attribute graphics relative to one another provides the priority indications solicited from the user.

10. The non-transitory computer-readable storage medium of claim 1, wherein a reassigned set of priority indications is solicited from the user prior to assembling result information.

11. The non-transitory computer-readable storage medium of claim 1, wherein result information is assembled by initially identifying a set of records which exhibit the domain attributes prioritised by a user.

12. The non-transitory computer-readable storage medium of claim 11, wherein the initially identified set of records has a relevance score calculated using the domain attributes exhibited by each record and the priority indications received from the user related to each domain attribute.

13. The non-transitory computer-readable storage medium of claim 12 wherein a relevance score is calculated using a weighted sum function where a numeric value representing each a domain attribute exhibited by a record is multiplied by a numeric value received as a related priority indication.

14. The non-transitory computer-readable storage medium of claim 11 wherein a collection of machine learning ranking models are generated for a domain identity.

15. The non-transitory computer-readable storage medium of claim 14 wherein one of the machine learning ranking models is selected based on priority indications received from a user, with the selected model being supplied with the received priority indications to produce a set of ranked results.

16. The non-transitory computer-readable storage medium of claim 1, wherein the result information consists of collections of individual records relating to internet published information.

17. The non-transitory computer-readable storage medium of claim 1, wherein one or more of the records presented as result information are interacted with by a user to trigger the presentation of additional information.

18. An information retrieval system including a processor programmed with computer executable instructions retrieved from non-transitory computer-readable storage medium configured to store instructions as claimed in claim 1, the instructions configured to:
solicit domain identity information from a user,
present domain attribute information to the user,
solicit from the user priority indications related at least one domain attribute presented to the user,
assemble result information using a set of priority indications received from the user, and
present result information to the user formatted using at least one received priority indication.

19. A method of information retrieval characterised by the steps of:
soliciting domain identity information from a user,
present domain attribute information to the user,
soliciting from the user priority indications in respect of at least one domain attribute,
assembling result information using a set of priority indications received from the user, and
presenting result information to the user formatted using at least one priority indication.
